(19) United States
(12) Patent Application Publication
(10) Pub. No.: US 2016/0098705 A1
(43) Pub. Date: Apr. 7, 2016

(54) CREDIT CARD WITH BUILT-IN SENSOR FOR FRAUD DETECTION

(71) Applicant: MasterCard International Incorporated, Purchase, NY (US)

(72) Inventor: Kaushal Kurapati, Cupertino, CA (US)

(21) Appl. No.: 14/505,254

(22) Filed: Oct. 2, 2014

(51) Int. Cl. G06Q 20/34; G06K 9/00; G10L 17/00; G06Q 20/40

(52) U.S. Cl. CPC G06Q 20/3574; G06Q 20/40145; G06K 9/00288; G10L 17/005

(57) ABSTRACT

A card includes a sensor system for fraud detection. A method of fraud detection includes flagging suspicious activity on a transaction card and prompting a user to take a self-image or a voice recording with the credit card.

### BACKGROUND

The present disclosure relates to a credit card system and method, and more particularly, to a credit card system and method with reduced potential of credit card number misuse.

The development of retail electronic commerce has been relatively slow in spite of the perceived demand for such trade. One great deterrent to the expansion of retail electronic commerce is the potential for fraud. This potential for fraud has been a major concern for the credit card companies and financial institutions, as well as the customers and the providers of the goods and services.

Credit card companies have an efficient credit card system, which operates well for face-to-face transactions, i.e., “card present” transactions where the credit card is physically presented to a trader, so that the trader can obtain the credit card number and compare signatures before accepting a particular credit card.

There are also particular personal concerns for the consumer in that the fraudulent use of the credit card number may not become apparent for some time. This can happen even if the card is still in the authorized cardholder's possession. Further, when fraud does occur, the consumer has the task of persuading the credit card provider that fraud by another did indeed occur.

There is also the additional fear of being overcharged on a credit card. There are thus particular risks for those credit cardholders who have relatively high spending limits, in that if fraud should occur, it may be some considerable time before it is detected. One particular form of fraud, referred to as “skimming,” is particularly difficult to control. What happens is that the cardholder proffers his or her card at an establishment to make a transaction, the relevant information is electronically and/or physically copied from the card, and the card is subsequently reproduced. This can be a particular problem with travelers, particularly during an extensive period of travel, as the fraudulent card may turn up in other places, and it may be some considerable time before the fraud is detected.

For remote credit card use, the credit cardholder has to provide details of name, credit card number, expiration date, Card Verification Value (CVV) number, and often many other pieces of information for verification, such as address, password, date-of-birth and/or various password-verifying information. The storing and updating of the information is expensive but necessary. This in and of itself is a considerable security risk, as one will appreciate that this information could be used to fraudulently charge goods and services to the cardholder's account or to obtain unauthorized access other accounts or resources of the user that may use the same types of information. Such fraudulent use is not limited to those people to whom the credit card information has been given legitimately, but extends to anybody who can illegitimately obtain such details. A major problem in relation to this form of fraud is that the credit card may still be in the possession of the legitimate holder as these fraudulent transactions are taking place. This is often referred to as “compromised numbers” fraud. Indeed, this fraud requires only one dishonest or negligent staff member, for example in a shop, hotel or restaurant, to record or accidentally transmit the credit card number. It is thus a distinct problem from theft of the physical card.

Certain current approaches to the limiting of credit card fraud rely on the theft of a card being reported and elaborate verification systems, whereby altered patterns of use initiate some inquiry from the credit card company. Many authorized credit cardholders receive telephone calls, or even have their legitimate use of a card suspended, when their use of the card has been exceptional or otherwise unusual in the eyes of the organization that provides the verification services. In cases of valid card use, these interruptions can be invasive and quite frustrating to consumers.

Thus, there have been many developments in an effort to overcome this fundamental problem of fraud, both in the general area of fraud for ordinary use of credit cards and for the particular problems associated with such remote use. A need exists for improved methods and systems for detecting and preventing fraud, while avoiding the difficulties in current methods.

### SUMMARY

A card according to one disclosed non-limiting embodiment of the present disclosure includes a sensor, which may include an imaging system and/or a system for recording audio. The sensor may include a video camera, a still camera, an audio recorder, or other facility for recording images and/or sounds in the environment of the card. References throughout this disclosure to a camera, a video camera, an imaging system, or a recording system should be understood to encompass all of these embodiments of recording of images and/or audio, except where context may prevent.

A credit card system according to one disclosed non-limiting embodiment of the present disclosure includes a first surface and a second surface. The first surface may include an account number and at least one of the first surface and the second surface may include an sensor system, such as a video camera. The card system may include a control module in communication with the sensor system and a communication system in communication with the control module.

A method of credit card fraud detection according to another disclosed non-limiting embodiment of the present disclosure includes flagging suspicious activity on a credit card and prompting a user to take a self-image or to record the user's voice via the camera of the credit card.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a credit card system;

FIG. 2 is a schematic view of a credit card with a camera according to one disclosed non-limiting embodiment; and

FIG. 3 is a flow chart illustrating a method of credit card fraud detection according to another disclosed non-limiting embodiment of the present disclosure.

### DETAILED DESCRIPTION

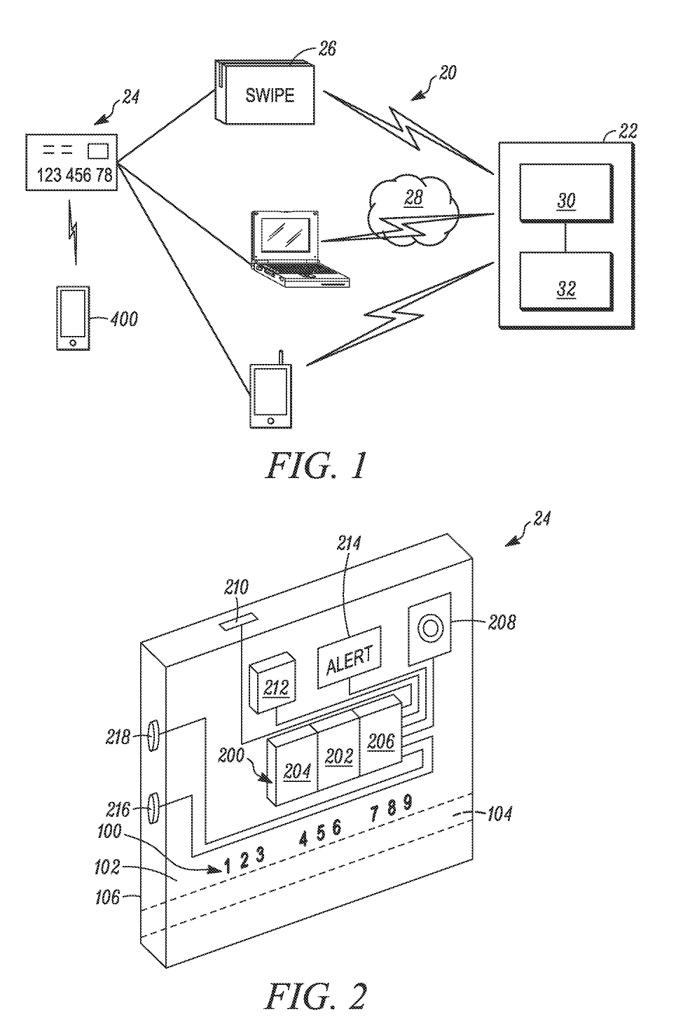

FIG. 1 schematically illustrates a credit card system 20. The system 20 generally includes a transactional processing system 22, which, accordingly to exemplary embodiments, may be operated by a host, such as the credit card provider or a third party processor on behalf of the credit card provider. Generally, this transactional processing system 22 receives and processes credit card transactions that are generated at retail locations or at locations remote from the card. The credit card transactions can originate from a merchant in the conventional manner, e.g., by swiping a credit card 24 through a card swipe unit 26. Alternatively, the credit card transaction requests can originate from any device, such as an electronic device (e.g., a personal computer, laptop, mobile phone, tablet, or other consumer device). The device can interface with the transactional processing system 22 through any type of network, including any type of public or propriety network, or some combination thereof, for instance, via the Internet 28. The transactional processing system 22 can also interface with other types of devices, such as wireless (e.g., cellular telephone) devices.

The transactional processing system 22 may include a processing facility, such as a processing system 30, that may interface with a data storage facility, such as a database system 32 that stores information regarding customers' accounts, such as information regarding various conditions that apply to each customer's account. The processing facility 30 can internally perform the approval and denial of credit card transaction requests by making reference to credit history information and other information in the conventional manner. Alternatively, this function can be delegated to a separate clearance processing facility as well as to a distributed transactional processing system. It should be understood that the transactional processing system 22, the processing system 30, and the database system 32 may be distributed across multiple locations as might be understood by one of skill in the art.

With reference to FIG. 2, the credit card 24, as generally understood, typically includes an account number 100 on one surface 102 of the credit card 24 and a magnetic strip 104 on the opposite surface 106 of the credit card 24. In the case of smart cards, the card may include a chip in addition to, or as an alternative to, the magnetic strip. The size of a typical credit card is typically about 3⅜×2⅛ in (85.60×53.98 mm), conforming to the ISO/IEC 7810 ID-1 standard. Credit cards have an account number 100 complying with the ISO/IEC 7812 numbering standard. Both of these standards are maintained and further developed by ISO/IEC JTC 1/SC 17/WG 1.

The account number 100 refers herein to the account number allocated by the provider to the authorized card user for his or her account. The account number 100 is typically raised from the surface 102 of the credit card 24. The magnetic strip 104 may often commonly be referred to as a swipe card or magstripe read by swiping past a magnetic reading head typical of the card swipe unit 26. In another disclosed non-limiting embodiment, the credit card 24 may be dynamic and provide for multiple cared numbers 100 representative of multiple credit cards such that the single credit card may essentially function as many credit cards.

In this specification, except where context prevents, the term “credit card” should be understood to encompass credit cards (MaterCard®, Visa®, etc.), charge cards (e.g., American Express®, etc), debit cards such as those usable at ATMs and many other locations or that are associated with a particular account, identification cards (such as a driver's license, student ID, library card, and the like), and various hybrids thereof that are often carried by a person to purchase goods and services or to allow access to the same, as well as provide identification. The identification card, which may be used to verify aspects of a person's personal identity issued in the form of a relatively small, mostly standard-sized card is usually called an identity card or ID.

The credit card 24 generally includes a control module 200 with a processor 202, a memory 204, and an interface 206. The processor 202 may be any type of microprocessor or processors having desired performance characteristics. The memory 204 may include any type of computer readable medium that stores the data and control algorithms 220 described herein below. Other operational software for the processor 202 may also be stored in the memory 204. The interface 206 facilitates communication with other systems such as a sensor 208, a communication system 210, a geo-location system 212, a display system 214, and/or an input/output device 216. It should be appreciated that although particular subsystems are separately defined, each or any of the subsystems may be combined or segregated via hardware and/or software of the system.

Examples of the sensor 208 include, but are not limited to, video cameras, digital cameras, imaging systems, charge coupled devices, audio recording systems, forward looking infrared, thermal systems and/or other imaging sensors and combinations thereof. The foregoing may have various optical elements, including lenses, micro-lenses, CMOS sensors and the like. It should be appreciated that other sensors, in addition, or alternatively to the image sensors such as a microphone will also benefit herefrom. That is, the sensor 208 may essentially take an image of the user's face or voice to provide authorization.

Examples of the communication system 210 include, but are not limited to, a wireless communication interface such as a wireless LAN (Wi-Fi) interface, cellular network interface, or other communication interface that ultimately permits communication with the transactional processing system 22 through any type of communication interface including any type of public or propriety networks, or some combination thereof, for instance, via the Internet 28 (FIG. 1).

Examples of the geo-location system 212 include, but are not limited to, Global Positioning Systems, radio navigation, and others.

Examples of the display system 214 include, but are not limited to, a liquid crystal display, light emitting diode (LED) displays, video display, HD display, text display, speakers, or other communication element that provides visual or audible communication with the cardholder.

Examples of the input/output device 216 include, but are not limited to, a button that triggers the sensor 208. It should be appreciated that the input/output device 216 may alternatively or additionally be displayed by the display system 214 and need not be a physical button. In embodiments, the sensor 208 may be triggered remotely, such as to record images and/or audio in the environment of the card, such as to record a party that may have stolen the card or to verify images and/or sounds in the environment of the card, such as to indicate or confirm the location of the card in a particular environment.

Examples of the power source 218 include, but are not limited to, a battery, fuel cell, or other active power source. Alternatively, a passive power source such a device that generates power from movement may be provided. Alternatively still, the power source 218 may derive power from an external source such as the action of swiping the credit card in the card reader or a placing the card in a chip reader.

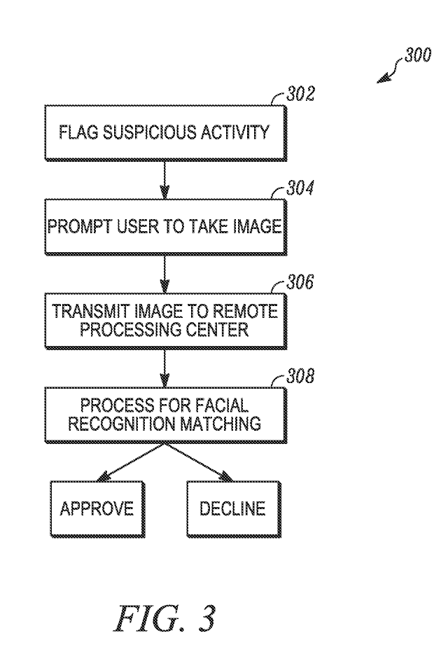

With reference to FIG. 3, in one disclosed non-limiting embodiment, an algorithm for operation of the credit card 24 is schematically illustrated. The functions of the algorithm 220 are disclosed in terms of functional block diagrams and it should be appreciated by those skilled in the art with the benefit of this disclosure that these functions may be enacted in either dedicated hardware circuitry or programmed software routines as a computer readable storage medium capable of execution as instructions in a microprocessor-based electronics control embodiment such as the control module 200. That is, the memory 204 is an example computer storage media having embodied thereon computer-useable instructions such as the algorithms 220 that, when executed, performs a method 300 of credit card fraud detection.

The method 300, effectuated by the algorithm 220, may be initiated by credit card fraud detection algorithms of the transactional processing system 22 (FIG. 1) that have flagged suspicious activity on the credit card 24 (step 302). That is, in response to the use of the credit card 24, the credit card fraud detection algorithms off board of the credit card 24 may “flag” the transaction for suspicious activity. It should be appreciated that the algorithm 220 may be performed on board the credit card 24 such as via the control module 200, off board the credit card 24 such as via the remote processing center 22, or combinations thereof as well as in a distributed or cloud based system.

In response to “flagging” of a transaction for suspicious activity, the remote processing center 22 will prompt the user to take an image of themselves (step 304) via the imaging system 208. That is, the cardholder must take an image of himself or herself that would be sufficient to, for example, be processed by facial recognition software. Further, the initial card authorization process may require the user to take an image sufficient to provide a baseline on file for later facial recognition matching in an automated manner.

In one disclosed non-limiting embodiment, the prompt may be communicated via a transaction interface, such as shopping cart, during an Internet purchase. That is, the website checkout may require the cardholder to take a self-picture prior to completion of the transaction. Alternatively, or in addition, the prompt may be provided on the credit card 24 such as, via a message on the display system 214, or a flashing light. Alternatively, or in addition, the prompt may be provided to a device 400 of the authorized cardholder, such as via text message to a mobile phone. Alternatively, the prompt may be provided by a device at a retailer, such as the card reading system at a point of sale system of the retailer.

In another disclosed non-limiting embodiment, the transactional processing system 22 will initiate selective operation of the imaging system 208 without user initiation (step 306). Such selective operation may be initiated upon the credit card 24 being separated from the device 400 (FIG. 1) by a predetermined distance determined via the geo-location system 212, or movement of the credit card 24 to a location not typical of the authorized cardholder.

In one disclosed non-limiting embodiment, the image is then transmitted to the transactional processing system 22 (step 306), where the image is matched with the authorized cardholder's image that is on file (step 308). Matching may be based on facial recognition technology. Facial recognition may be accomplished by any of a variety of known techniques, including geometric techniques that look at distinguishing facial features, such as size, relative size, distances, and angles among recognizable elements, such as eyes, nose, mouth, chin, and the like, and including photometric or statistical approaches that reduce elements (e.g., pixels) or regions of image into values that are compared with templates to identify the extent of variances, Any technique known to one of ordinary skill in the art is intended to be encompassed herein, including linear discriminate analysis, principal component analysis using Eigen faces, hidden Markov models, elastic bunch graph matching (e.g., using the Fisherface algorithm), and learning models (e.g., multi-linear subspace learning using tensor representations and neuronal motivated dynamic link matching). Matching may also be based on voice recognition technology, also known as speaker recognition or verification technology. This may include various approaches known to those of skill in the art, including techniques that use acoustical features that emerge from the anatomy of the user and behavioral techniques that relate to pitch, frequency, or patterns of speaking by an individual. If the match is determined (e.g., if a match percentage is above a certain threshold in a statistical technique), then the transaction transactional processing system 22 can ascertain that the person who has the card is the authorized cardholder and the block or flag on suspicious activity can be lifted. If the match percentage is below the threshold, a further ‘flag’ is placed on the transaction as potentially fraudulent and a full hold may be put on the credit card 24 until the authorized cardholder contacts the remote processing center 22 to resolve the issue.

In another disclosed non-limiting embodiment, the image of the user captured by the sensor 208 during a transaction may be processed on the credit card 24 itself to confirm that the image is matched with the authorized cardholder's image, such as comparing to an image that is stored in the memory 204 during the initial card authorization process. In this non-limiting embodiment, no communication with the transaction transactional processing system 22 need be performed unless, for example, the match percentage or other indicator of facial or voice recognition is below the threshold and the authorized cardholder must contact the remote processing center 22 to resolve the issue.

The credit card 24 disclosed herein envisions a further way to ascertain that the credit card is in the hands of the authorized cardholder through an automated image matching mechanism. Of course this does not apply when the physical card itself is in the possession of the cardholder but the account number has been compromised. Also, leveraging a card built-in camera for fraud detection would be an additional deterrent to theft of physical credit cards.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Except where context indicates otherwise, the terms “cardholder,” “consumer,” “customer,” “end user” and “user” are used interchangeably to refer to an entity, e.g., an individual, that has been rightfully issued a credit/debit/charge card number, e.g., through a contractual arrangement, or that has been authorized to use such card by such entity or a representative of such entity.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A card, comprising:
a sensor operable to capture at least one of, an image for facial recognition, and a voice for voice recognition; and
a communication system for transmitting at least one of the image and the voice with a matching indicator determined by a transactional processing system that is remote from the card.

2. The card as recited in claim 1, wherein said card includes a first surface and a second surface, said first surface includes an account number.

3. The card as recited in claim 2, wherein said second surface includes a magnetic strip.

4. The card as recited in claim 1, further comprising a control module in communication with said sensor.

5. The card as recited in claim 1, wherein said communication system includes a wireless interface.

6. The card as recited in claim 5, wherein said communication system includes a cellular interface.

7. The card as recited in claim 4, further comprising a geo-location system in communication with said control module.

8. The card as recited in claim 4, further comprising a display system in communication with said control module.

9. The card as recited in claim 4, further comprising an input/output system in communication with said control module.

10. The card as recited in claim 1, wherein said card is a credit card.

11. The card as recited in claim 1, wherein said card is an identity card.

12. The card as recited in claim 1, wherein said card is about 3⅜×2⅛ in (85.60×53.98 mm)

13. A credit card system, comprising:
a first surface and a second surface, said first surface includes an account number and one of said first surface and said second surface includes a sensor for capturing at least one of an image and a voice of a cardholder;
a control module in communication with said sensor; and
a communication system in communication with said control module.

14. The system as recited in claim 13, wherein one of said first surface and said second surface includes a magnetic strip.

15. The system as recited in claim 13, further comprising a communication system in communication with said control module, said control system operable to communicate with a remote transaction transactional processing system.

16. The system as recited in claim 15, wherein said remote transaction transactional processing system includes a facial recognition algorithm operable to match an image from the imaging system with an image on file of an authorized cardholder.

17. The system as recited in claim 16, wherein said sensor includes a camera.

18. The system as recited in claim 16, wherein said sensor includes an audio recorder.

19. The system as recited in claim 13, further comprising a geo location system in communication with said control module.

20. The system as recited in claim 13, further comprising a display system in communication with said control module.

21. The system as recited in claim 13, further comprising an input/output system in communication with said control module.

22. The system as recited in claim 13, wherein said card is about 3⅜2⅛ in (85.60×53.98 mm).

23. The system as recited in claim 13, further comprising a matching module under the control of the control module for matching at least one of an image and a voice captured by the camera to at least one of a stored image and a stored voice of the card holder.

24. A method of credit card fraud detection, comprising:
flagging suspicious activity on a credit card; and
prompting a user to take a self-image via a camera of the credit card.

25. The method as recited in claim 24, wherein flagging suspicious activity on the credit card is performed by a credit card fraud detection algorithm off board of the credit card.

26. The method as recited in claim 25, wherein flagging suspicious activity on the credit card is performed at a remote transaction processing center.

27. The method as recited in claim 25, wherein flagging suspicious activity on the credit card is performed in response to a use of the credit card account number.

28. The method as recited in claim 25, wherein flagging suspicious activity on the credit card is performed in response to a location of the credit card.

29. The method as recited in claim 24, wherein prompting the user to take the self-image is effected via a transaction interface.

30. The method as recited in claim 29, wherein the transaction interface is a shopping cart during an Internet purchase.

31. The method as recited in claim 24, wherein prompting the user to take the self-image is effected via a display on the credit card.

32. The method as recited in claim 31, wherein the display is a light.

33. The method as recited in claim 24, wherein prompting the user to take the self-image of is effected via a mobile device of the authorized cardholder of the credit card.

34. The method as recited in claim 24, further comprising transmitting the image to a remote processing center.

35. The method as recited in claim 34, further comprising performing an automated facial recognition to compare the image with an authorized cardholder's image on file.

36. The method as recited in claim 34, further comprising performing an automated facial recognition to compare the image with an authorized cardholder's image stored in memory on board the credit card.
